(19) United States
(12) Patent Application Publication
(10) Pub. No.: US 2014/0070779 A1
(43) Pub. Date: Mar. 13, 2014

(54) SWITCHING REGULATOR

(71) Applicants: Yoshiki Takagi, Hyogo (JP); Yuki Kashima, Osaka (JP)

(72) Inventors: Yoshiki Takagi, Hyogo (JP); Yuki Kashima, Osaka (JP)

(73) Assignee: RICOH COMPANY, LTD., Tokyo (JP)

(21) Appl. No.: 14/023,678

(22) Filed: Sep. 11, 2013

(30) Foreign Application Priority Data
Sep. 13, 2012 (JP) 2012-201689

(51) Int. Cl. H02M 3/158

(52) U.S. Cl. CPC H02M 3/1588
USPC 323/271

(57) ABSTRACT

A switching regulator includes a coil, switching transistor, a synchronous rectifying transistor, a switching control circuit, a comparator, a first buffer circuit operated by an input voltage, and a second buffer circuit operated by an output voltage. The switching control circuit assumes control such that control signals are outputted from the first buffer circuit to a switching transistor and a synchronous rectifying transistor, respectively, in response to a power supply switching signal indicating that the output voltage is lower than the input voltage, while the switching control circuit assumes control such that the control signals are outputted from the second buffer circuit to the switching transistor and the synchronous rectifying transistor, respectively, in response to the power supply switching signal indicating that the output voltage is equal to or higher than the input voltage.

### CROSS-REFERENCE TO RELATED APPLICATION

This patent application is based on and claims priority pursuant to 35 U.S.C. §119 to Japanese Patent Application No. 2012-201689, filed on Sep. 13, 2012 in the Japan Patent Office, the entire disclosure of which is hereby incorporated by reference herein.

### BACKGROUND

1. Technical Field

The present disclosure relates to a switching regulator, and more particularly to a step-up switching regulator including a synchronous rectifying transistor.

2. Related art

First of all, a description will be given of a step-up switching regulator according to a conventional technology. FIG. 14 is a block diagram illustrating a configuration of a related-art switching regulator 1X according to the conventional technology. Referring to FIG. 14, the switching regulator 1X according to the conventional technology includes a pulse width modulation (hereinafter, referred to as the PWM) logic circuit 51 serving as a switching control circuit, a buffer circuit 52, the other internal circuit 50, a comparator 20, inverters 21 and 27, a coil 23, a switching transistor 24 serving as an NMOS field effect transistor, a synchronous rectifying transistor 25 serving as a PMOS field effect transistor, an enable circuit 26, a capacitor 28, power supply switching switches SW1 and SW2, back gate switches SB1 and SB2, an input terminal T1, and an output terminal T2.

Here, the coil 23 and the switching transistor 24 are connected in series through a junction node Lx, between the input terminal T1 and ground, and the junction node Lx is connected to the output terminal T2 through the synchronous rectifying transistor 25. In addition, the capacitor 28 is connected between the output terminal T2 and the ground. Furthermore, the back gate switch SB1 is connected between a back gate of the synchronous rectifying transistor 25 and the junction node Lx, and the back gate switch SB2 is connected between the back gate of the synchronous rectifying transistor 25 and the output terminal T2. The enable circuit 26 generates a low-level enable signal S26 when the switching regulator 1X is in a standby state, while the enable circuit 26 generates the high-level enable signal S26 when the switching regulator 1X is in an active state. The enable signal S26 is directly outputted to the back gate switch SB2, and outputted to the back gate switch SB1 through the inverter 27. In response to the high-level enable signal S26, the back gate switch SB1 is turned off, and the back gate switch SB2 is turned on. Meanwhile, in response to the low-level enable signal S26, the back gate switch SB1 is turned on, and the back gate switch SB2 is turned off.

The PWM logic circuit 51 generates control signals Sn51 and Sp51 to turn on the switching transistor 24 and the synchronous rectifying transistor 25 in a complementary way so that an output voltage Vout from the output terminal T2 reaches a predetermined voltage, and outputs the control signals Sn51 and Sp51 to the buffer circuit 52. In addition, the buffer circuit 52 outputs the control signals Sn51 and Sp51 to gates of the switching transistor 24 and the synchronous rectifying transistor 25, respectively, as control signals Sn52 and Sp52.

In addition, while an input voltage Vin is outputted to a non-inverting input terminal of the comparator 20, the output voltage Vout is outputted to an inverting input terminal of the comparator 20. The comparator 20 generates a high-level power supply switching signal S20 when the output voltage Vout is lower than the input voltage Vin, while the comparator 20 generates the low-level power supply switching signal S20 when the output voltage Vout is equal to or higher than the input voltage Vin. The power supply switching signal S20 is directly outputted to the switch SW2, and outputted to the switch SW1 through the inverter 21. When the output voltage Vout is lower than the input voltage Vin, the switch SW1 is turned on and the switch SW2 is turned off, and the input voltage Vin is supplied to the PWM logic circuit 51, the buffer circuit 52, and the other internal circuit 50, as a power supply voltage Vddi in an IC of the switching regulator 1X. In addition, when the output voltage Vout is equal to or higher than the input voltage Vin, the switch SW1 is turned off and the switch SW2 is turned on, and the output voltage Vout is supplied to the PWM logic circuit 51, the buffer circuit 52, and the other internal circuit 50, as the internal power supply voltage Vddi in the 1C of the switching regulator 1x. The PWM logic circuit 51, the buffer circuit 52, and the other n al circuit 50 are operated by the internal power supply voltage Vddi.

Therefore, when the output voltage Vout becomes equal to or higher than the input voltage Vin after the start of the step-up switching regulator 1X in FIG. 14, the PWM logic circuit 51, the buffer circuit 52, and the other internal circuit 50 can be operated by the output voltage Vout equal to or higher than the input voltage Vin. Therefore, efficiency can be improved because of a reduction in on resistance of the switching transistor 24 and the synchronous rectifying transistor 25. In addition, even when the input voltage Vin becomes lower than that at the time of the start, the switching regulator 1X can be stably operated by the output voltage Vout.

In addition, when the switching regulator 1X is in the active state, the back gate switch SB2 is turned on, and the back gate switch SB1 is turned off, so that the voltage of the back gate of the synchronous rectifying transistor 25 substantially reaches the output voltage Vout. Therefore, an anode of a parasitic diode of the synchronous rectifying transistor 25 is connected to the junction node Lx, and a cathode thereof is connected to the output terminal T2, so that a current path is cut from the output terminal T2 to the input terminal T1. Meanwhile, when the switching regulator 1X is in the standby state, the back gate switch SB2 is turned off, and the back gate switch SB1 is turned on, so that a potential of the back gate of the synchronous rectifying transistor 25 substantially reaches a potential of the junction node Lx. Therefore, the anode of the parasitic diode of the synchronous rectifying transistor 25 is connected to the output terminal T2, and the cathode thereof is connected to the junction node Lx, so that a current path is cut from the input terminal T1 to the output terminal T2.

However, since the above switching regulator 1X according to the conventional technology has some problems, and efficiency could be deteriorated, and distortion could be generated in the output voltage Vout depending on operation conditions.

### SUMMARY

The present invention is conceived in view of the above-described circumstances, and provides a switching regulator superior in efficiency and stability with a simple circuit configuration.

In one embodiment of the present disclosure, there is provided a switching regulator that includes an input terminal, an output terminal, a coil, a switching transistor, a synchronous rectifying transistor, a switching control circuit, a comparator, a first buffer circuit, and a second buffer circuit. An input voltage is input through the input terminal. The output terminal outputs an output voltage. The coil has one end connected to the input terminal. The switching transistor is connected between the other end of the coil and the ground, and driven by an inputted first control signal. The synchronous rectifying transistor is connected between a junction node between the coil and the switching transistor, and the output terminal, and driven by an inputted second control signal. The switching control circuit controls the switching transistor and the synchronous rectifying transistor so as to convert an input voltage inputted through the input terminal into a predetermined output voltage for output through the output terminal. The comparator compares the output voltage with the input voltage, and generates a power supply switching signal indicating the compared result. The first buffer circuit is operated by the input voltage. The second buffer circuit is operated by the output voltage. The switching control circuit assumes control such that the first and second signals are outputted from the first buffer circuit to the switching transistor and the synchronous rectifying transistor, respectively, in response to a power supply switching signal indicating that the output voltage is lower than the input voltage, while the switching control circuit assumes control such that the first and second control signals are outputted from the second buffer circuit to the switching transistor and the synchronous rectifying transistor, respectively, in response to a power supply switching signal indicating that the output voltage is equal to or higher than the input voltage.

In another embodiment of the present disclosure, there is provided a switching regulator that includes an input terminal, an output terminal, a coil, a switching transistor, a synchronous rectifying transistor, a first back gate switch, a second back gate switch, a switching control circuit, and a back gate control circuit. An input voltage is input through the input terminal. The output terminal outputs an output voltage. The coil has one end connected to the input terminal. The switching transistor is connected between the other end of the coil and the ground. The synchronous rectifying transistor is connected between a junction node between the coil and the switching transistor, and the output terminal. The first back gate switch is connected between a back gate of the synchronous rectifying transistor and the junction node. The second back gate switch is connected between the back gate of the synchronous rectifying transistor and the output terminal. The switching control circuit controls the switching transistor and the synchronous rectifying transistor so as to convert an input voltage inputted through the input terminal into a predetermined output voltage for output through the output terminal. The back gate control circuit controls the first and second back gate switches. The back gate control circuit assumes control such that when the output voltage is lower than the input voltage, and the switching transistor is in an on state, the first back gate switch is turned off and the second back gate switch is turned off, when the output voltage is lower than the input voltage, and the switching transistor is in an off state, the first back gate switch is turned on and the second back gate switch is turned off, and when the output voltage is equal to or higher than the input voltage, the first back gate switch is turned off and the second back gate switch is turned on, and the synchronous rectifying transistor is controlled so as to be always turned off when the output voltage is lower than the input voltage, while the synchronous rectifying transistor is controlled so as to be turned on in a complementary way with the switching transistor when the output voltage is equal to or higher than the input voltage.

In yet another embodiment of the present disclosure, there is provided a switching regulator that includes the input terminal, the output terminal, the coil, a switching transistor, a synchronous rectifying transistor, a first back gate switch, a second back gate switch, a switching control circuit, and a back gate control circuit. The switching transistor is connected between the other end of the coil and the ground. The synchronous rectifying transistor is connected between a junction node between the coil and the switching transistor, and an output terminal. The first back gate switch is connected between a back gate of the synchronous rectifying transistor and the junction node. The second back gate switch is connected between the back gate of the synchronous rectifying transistor and the output terminal. The switching control circuit controls the switching transistor and the synchronous rectifying transistor so as to convert an input voltage inputted through the input terminal into a predetermined output voltage and outputted from the output terminal. The back gate control circuit controls the first and second back gate switches. The back gate control circuit switches the second back gate switch from off to on, or from on to off when the synchronous rectifying transistor is in an off state.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is block diagram illustrating a configuration of a switching regulator according to a first embodiment of the present disclosure;

FIG. 2 is block diagram illustrating a configuration of a switching regulator according to a second embodiment of the present disclosure;

FIG. 3 is a timing chart illustrating an operation of the switching regulator in FIG. 1 when a voltage level of a power supply switching signal S20 is changed from a high level to a low level;

FIG. 4 is a timing chart illustrating an operation of the switching regulator in FIG. 2 when the voltage level of the power supply switching signal S20 is changed from the high level to the low level;

FIG. 5 is a timing chart illustrating an operation of the switching regulator in FIG. 2 when the voltage level of the power supply switching signal S20 is changed from the low level to the high level;

FIG. 6 is a block diagram illustrating a configuration of a switching regulator according to a third embodiment of the present disclosure;

FIG. 7 is a timing chart illustrating an operation of the switching regulator in FIG. 6;

FIG. 8 is a block diagram illustrating a configuration of a switching regulator according to a fourth embodiment of the present disclosure;

FIG. 9 is a timing chart illustrating an operation of the switching regulator in FIG. 6;

FIG. 10 is a timing chart illustrating an operation of the switching regulator in FIG. 8;

FIG. 11 is a block diagram illustrating a configuration of a switching regulator according to a fifth embodiment of the present disclosure;

FIG. 12 is a circuit diagram illustrating a configuration of a setting signal monitoring circuit 90 and an output circuit 100 in FIG. 11;

FIG. 13 is a block diagram illustrating a configuration of a switching regulator according to a sixth embodiment of the present disclosure; and

FIG. 14 is a block diagram illustrating a configuration of a related-art switching regulator.

### DESCRIPTION OF THE PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

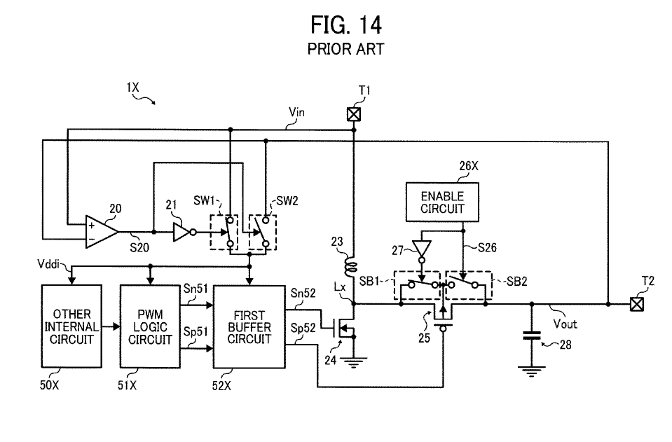

In order to facilitate an understanding of the non-predictable effects of the present invention, a description is first given of several comparative examples, with reference to FIG. 14. Referring to FIG. 14, the switching regulator 1X according to the conventional technology includes a pulse width modulation (hereinafter, referred to as the PWM) logic circuit 51 serving as a switching control circuit, a buffer circuit 52, another internal circuit 50, a comparator 20, inverters 21 and 27, a coil 23, a switching transistor 24 serving as an NMOS field effect transistor, a synchronous rectifying transistor 25 serving as a PMOS field effect transistor, an enable circuit 26, a capacitor 28, power supply switching switches SW1 and SW2, back gate switches SB1 and SB2, an input terminal T1, and an output terminal T2.

First Problem

Referring to FIG. 14, while the buffer circuit 52 to drive the switching transistor 24 and the synchronous rectifying transistor 25 is operated by the internal power supply voltage Vddi, a switching current flows in the buffer circuit 52 at the time of driving the transistors 24 and 25. When the size of the transistors 24 and 25 is relatively small, a size of the buffer circuit 52 to drive the transistors 24 and 25 is also relatively small, so that the switching current does not matter. However, when on resistance of the transistors 24 and 25 is reduced, and the size is increased in order to adapt the transistors 24 and 25 to a large current, size of the buffer circuit 52 is accordingly increased, and the switching current is also increased. As a result, the internal power supply voltage Vddi is considerably reduced due to an influence of on resistance of the switch SW1 or SW2. Thus, when the switching transistor 24 is turned on, the voltage level of the high-level control signal Sp52 is reduced, and the synchronous rectifying transistor 25 which is to be turned off in response to the high-level control signal Sp52 is turned on, so that a current reversely flows from the output terminal T2 to the ground through the synchronous rectifying transistor 25 and the switching transistor 24, which deteriorates the efficiency.

In order to solve this problem, a step-up switching regulator described in a first comparative example of JP-2008-193866-A includes a first switch connected to a first buffer to drive a switching transistor, and a second switch connected to a second buffer to drive a synchronous rectifying transistor, and a voltage which is higher of the input voltage and the output voltage is supplied to the first buffer through the first switch, and supplied to the second buffer through the second switch, as a power supply voltage. Therefore, an inrush current at the time of driving the switching transistor does not affect the synchronous rectifying transistor. However, the on resistance of the second switch affects the synchronous rectifying transistor, and a voltage level of a high-level control signal outputted to the gate of the synchronous rectifying transistor is reduced for a moment. When the switching transistor and the synchronous rectifying transistor are controlled so as to be both turned off at some timing, the reduction in gate voltage of the synchronous rectifying transistor causes the synchronous rectifying transistor to be turned on, and as a result, efficiency is deteriorated. In order to avoid this, a size of the second switch is to be increased to reduce the on resistance of the switch, and a capacitor having relatively high capacity for stabilization is to be mounted between an output unit of an internal power supply voltage and the ground, but a layout area is considerably increased.

Second Problem

When the step-up switching regulator is started from the standby state, the output voltage Vout is increased from the ground level. Therefore, the switching regulator is in a step-down state until the output voltage Vout reaches the input voltage Vin, and becomes a step-up state after it has reached the input voltage Vin. As for the switching regulator 1X according to the conventional technology in FIG. 14, as described above, the back gate switch SB2 is turned off and the back gate switch SB1 is turned on at the time of the standby state, so that the current path is cut from the input terminal T1 to the output terminal T2. However, when the switching regulator 1X is started and is in the active state, the back gate switch SB2 is turned on and the back gate switch SB1 is turned off, so that a large current flows from the input terminal T1 to the output terminal T2 through the parasitic diode of the synchronous rectifying transistor 25 before the output voltage Vout reaches the input voltage Vin.

In order to solve the second problem, as for a step-up switching regulator described in a second comparative example of JP2008-219955-A, under a condition that a switching transistor is in an off state, a synchronous rectifying transistor is gradually turned on, in a startup period in which a step-up stop state is shifted to a step-up operation state in the step-up switching regulator. In addition, as for a step-up DC-DC converter described in a third comparative example of JP2010-081748-A, a gate voltage supplied to a synchronous rectifying transistor is gradually fluctuated to gradually turn on the synchronous rectifying transistor at the time of startup of the DC-DC converter. In addition, as for a step-up switching regulator described in a fourth comparative example of JP2009-178033-A, a switching transistor is turned off and a synchronous rectifying transistor is switched, or the switching transistor and the synchronous rectifying transistor are turned off and a back gate switch (such as the back gate switch SB2 in FIG. 14) is switched, in a first period in which a step-up stop state is shifted to a step-up operation state in the switching regulator.

However, according to the switching regulators in the second and third comparative examples, the inrush current can be prevented, but in the case where the input voltage Vin is equal to or higher than the set output voltage Vout, the input voltage Vin is outputted from the output terminal T2 through the parasitic diode of the synchronous rectifying transistor 25, which causes a new problem. In addition, according to the switching regulators in the second, third, and fourth comparative examples, the switching transistor is in the off state at the time of startup, so that it is necessary to provide an overcurrent protection circuit on the side of the synchronous rectifying transistor, in order to prevent the inrush current. In general, in order to suppress the inrush current at the time of step-up operation (output voltage Vout>input voltage Vin), the overcurrent protection is provided on the side of the switching transistor, so that according to the switching regulators in the second, third, and fourth comparative examples, the extra overcurrent protection circuit needs to be provided. In addition, it is necessary to additionally provide a soft start circuit to increase the output voltage at a constant slope, in the synchronous rectifying transistor, so that a circuit configuration becomes considerably complicated.

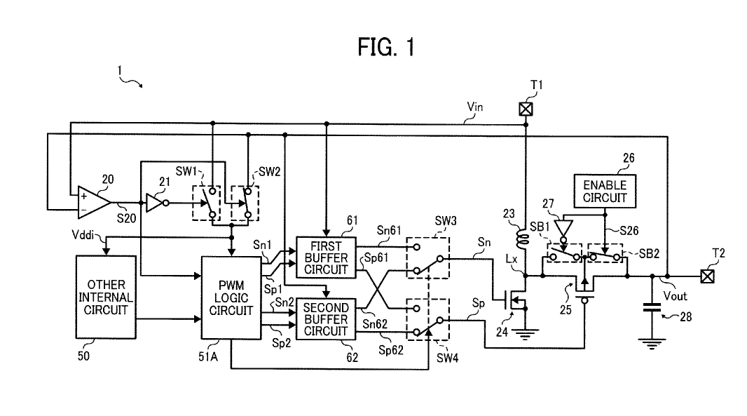

Referring now to the drawings, wherein like reference numerals designate identical or corresponding parts throughout the several views, particularly to FIGS. 1 through 13, a switching regulator according to illustrative embodiments is described. Hereinafter, embodiments according to the present invention will be described with reference to the drawings. In addition, in each embodiment below, the same component is marked with the same reference sign.

(First Embodiment)

FIG. 1 is a block diagram illustrating a configuration of a switching regulator 1 according to a first embodiment of the present disclosure. The switching regulator 1 according to the present embodiment is a step-up switching regulator. Referring to FIG. 1, the switching regulator 1 according to the present embodiment includes a PWM logic circuit 51A serving as a switching control circuit, buffer circuits 61 and 62, the other internal circuit 50, the comparator 20, the inverters 21 and 27, the coil 23, the switching transistor 24 serving as the NMOS field effect transistor, the synchronous rectifying transistor 25 serving as the PMOS field effect transistor, the enable circuit 26, the capacitor 28, the power supply switching switches SW1 and SW2, the back gate switches SB1 and SB2, switches SW3 and SW4, the input terminal T1, and the output terminal T2. In addition, in the present embodiment and following embodiments, the same component as that in the switching regulator 1X according to the conventional technology in FIG. 14 is marked with the same reference sign, and its description is omitted. Hereinafter, points different from the switching regulator 1x in FIG. 14 will be described.

Referring to FIG. 1, the internal power supply voltage Vddi is supplied to the PWM logic circuit 51A and the other internal circuit 50 through the power supply switching switch SW1 or SW2, similar to the switching regulator 1X in FIG. 14. In addition, the input voltage Vin is directly supplied to the first buffer circuit 61 as a power supply voltage, while the output voltage Vout is directly supplied to the second buffer circuit 62 as a power supply voltage. When the output voltage Vout is lower than the input voltage Vin, the PWM logic circuit 51A generates a control signal Sn1 to turn on/off the switching transistor 24, and a high-level control signal Sp1 to turn off the synchronous rectifying transistor 25, in response to the high-level power supply switching signal S20, and outputs the control signals Sn1 and Sp1 to the first buffer circuit 61. Meanwhile, when the output voltage Vout is equal to or higher than the input voltage Vin, the PWM logic circuit 51A generates control signals Sn2 and Sp2 to turn on the switching transistor 24 and the synchronous rectifying transistor 25 in a complementary way, in response to the low-level power supply changing signal S20, and outputs the control signals Sn2 and Sp2 to the second buffer circuit 62.

The first buffer circuit 61 is supplied with the input voltage Vin as the power supply voltage, and outputs the inputted control signal Sn1 to the switch SW3 as a control signal Sn61, while outputting the inputted control signal Sp1 to the switch SW4 as a control signal Sp61. In addition, the second buffer circuit 62 is supplied with the output voltage Vout as the power supply voltage, and outputs the inputted control signal Sn2 to the switch SW3 as a control signal Sn62, while outputting the inputted control signal Sp2 to the switch SW4 as a control signal Sp62. The PWM logic circuit 51A switches the switches SW3 and SW4 in conjunction with each other, to a side of the first buffer circuit 61, in response to the high-level power supply change-over signal S20, while switching them in conjunction with each other, to a side of the second buffer circuit 62, in response to the low-level power supply switching signal S20. Thus, the control signal Sn61 or Sn62 is outputted as a control signal Sn to a gate of the switching transistor 24 through the switch SW3, and the control signal Sp61 or Sp62 is outputted as a control signal Sp to a gate of the synchronous rectifying transistor 25 through the switch SW4. In addition, each of the switches SW3 and SW4 includes a pair of transmission gates.

The switching regulator 1 according to the present embodiment is different from the switching regulator 1x in FIG. 14, in that the switching regulator 1 includes the first buffer circuit 61 operated by the input voltage Vin to drive the switching transistor 24 and the synchronous rectifying transistor 25, and the second buffer circuit 62 operated by the output voltage Vout to drive the switching transistor 24 and the synchronous rectifying transistor 25. The PWM logic circuit 51A outputs the control signals Sn1 and Sp1 or the control signals Sn2 and Sp2 to one of the two buffer circuits 61 and 62, based on the power supply switching signal S20. Furthermore, the control signals Sn61 and Sp61 or the control signals Sn62 and Sp62 outputted from the operating buffer circuit 61 or 62 are outputted to the gates of the switching transistor 24 and the synchronous rectifying transistor 25, as the control signals Sn and Sp, respectively. At this time, the input voltage Vin and the output voltage Vout are outputted to the buffer circuits 61 and 62, respectively without going through the switch, so that even when an inrush current flows in the buffer circuits 61 and 62, a voltage level of each of the high-level control signals Sn61, Sp61, Sn62, and Sp62 from the buffer circuits 61 and 62 is not reduced. Therefore, the synchronous rectifying transistor 25 is not turned on at the timing when the synchronous rectifying transistor 25 is to be turned off, for example, so that the switching regulator can be superior in efficiency and stability, compared with the conventional technology.

In addition, the number of the buffer circuits is double in the switching regulator 1 according to the present embodiment, compared with the switching regulator 1X in FIG. 14, but a large-size switch and a capacitor for stabilization are not needed, so that a layout area of the whole switching regulator is reduced. In addition, since it is necessary to supply the internal power supply voltage Vddi to the other internal circuit 50 and the PWM logic circuit 51A, the switches SW1 and SW2 need to be provided similar to the switching regulator 1X in FIG. 14. However, in general, a current flowing in the PWM logic circuit 51A and the other internal circuit 50 through the switches SW1 and SW2 is about several tens of μA, so that the size of the switches SW1 and SW2 can be very small, and the switches SW1 and SW2 do no cause an increase in size in the switching regulator 1.

In addition, according to the present embodiment, the PWM logic circuit 51A outputs the control signals Sn1 and Sp1 or the control signals Sn2 and Sp2 to one of the two buffer circuits 61 and 62, based on the power supply switching signal S20, but the present disclosure is not limited to this. The PWM logic circuit 51A may only operate the second buffer circuit 62 in response to the high-level power supply switching signal S20, and only operate the buffer circuit 62 in response to the low-level power supply switching signal S20. In addition, the PWM logic circuit 51A may operate the buffer circuits 61 and 62 constantly irrespective of the power supply switching signal S20, and switch the switches SW3 and SW4 in conjunction with each other, to the side of the buffer circuit 61 in response to the high-level power supply switching signal S20 while the PWM logic circuit 51A may switch the switches SW3 and SW4 in conjunction with each other, to the side of the second buffer circuit 62 in response to the low-level power supply switching signal S20. The PWM logic circuit 51A may control at least one of the buffer circuits 61 and 62, and the switches SW3 and SW4 in such a manner that in response to the power supply switching signal S20 indicating that the output voltage Vout is lower than the input voltage Vin, the control signals Sn61 and Sp61 from the first buffer circuit 61 are outputted to the switching transistor 24 and the synchronous rectifying transistor 25 as the control signals Sn and Sp, respectively, and in response to the power supply switching signal S20 indicating that the output voltage Vout is equal to or higher than the input voltage Vin, the control signals Sn62 and Sp62 from the second buffer circuit 62 are outputted to the switching transistor 24 and the synchronous rectifying transistor 25 as the control signals Sn and Sp, respectively.

With this configuration, the switching regulator 1 is superior in efficiency and stability with a simple circuit configuration, compared with the conventional technology.

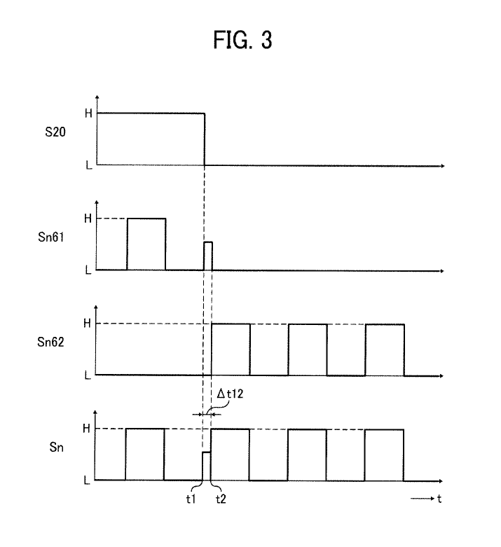

FIG. 3 is a timing chart illustrating an operation of the switching regulator 1 in FIG. 1 when the voltage level of the power supply switching signal S20 is switched from the high level to the low level. As described in the first embodiment, at the timing when the voltage level of the power supply switching signal S20 is switched from the high level to the low level, the PWM logic circuit 51A assumes control such that the control signals Sn62 and Sp62 are outputted from the second buffer circuit 62 as the control signals Sn and Sp, instead of the control signals Sn61 and Sp61 from the first buffer circuit 61. However, the output timing of the control signals Sn62 and Sp62 from the second buffer circuit 62 could lag behind the switching timing of the voltage level of the power supply switching signal S20, due to an operation delay of a logic circuit in the second buffer circuit 62 and a delay of a parasitic element caused by a layout. For example, as shown in FIG. 3, the voltage level of the power supply switching signal S20 is switched from the high level to the low level at a timing t1, but the control signal Sn62 rises at a timing t2 lagging behind the timing t1 by a delay time Δt12. Therefore, the low-level control signal Sn is outputted at the timing t1. Thus, the switching transistor 24 which is to be turned on in response to the high-level control signal Sn at the timing t1 is not turned on at the timing t1. Meanwhile, the synchronous rectifying transistor 25 which is to be turned on in a complementary way with the switching transistor 24, in response to the low-level power supply switching signal S20 is turned on at the timing t1. As a result, the output voltage Vout becomes unstable.

(Second Embodiment)

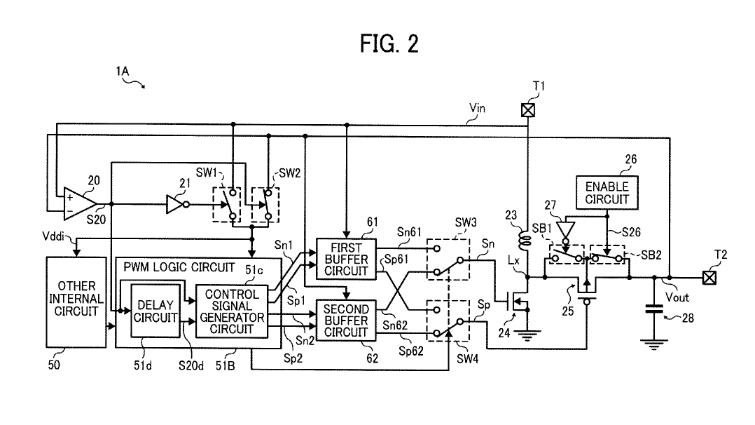

FIG. 2 is a block diagram illustrating a configuration of a switching regulator 1A according to a second embodiment of the present disclosure. Referring to FIG. 2, in order to solve the above problems shown in FIG. 3, the switching regulator 1A according to the present embodiment includes a PWM logic circuit 51B serving as the switching control circuit having a delay circuit 51d and a control signal generator circuit 51c, instead of the PWM logic circuit 51A in FIG. 1. Here, the delay circuit 51d generates a delay power supply switching signal S20d after lagging behind the power supply switching signal S20 by a predetermined delay time Δt51, and outputs it to the control signal generator circuit 51c. In addition, the delay time Δt51 is set so as to be longer than the above Δt12.

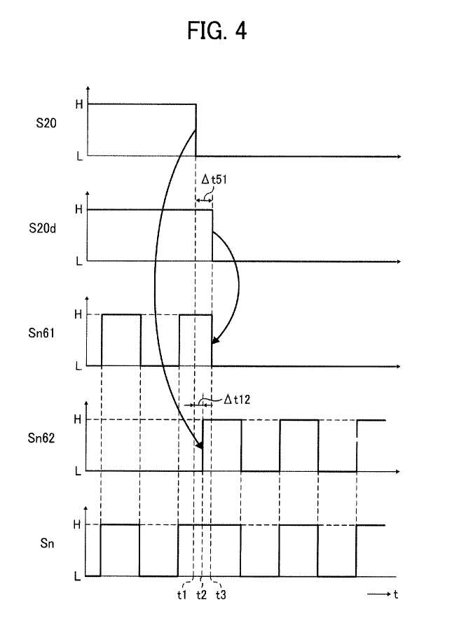

FIG. 4 is a timing chart illustrating an operation of the switching regulator 1A in FIG. 2 when the voltage level of the power supply switching signal S20 is switched from the high level to the low level. When the voltage level of the power supply switching signal S20 is at the high level, the control signal generator circuit 51c generates and outputs the control signals Sn1 and Sp1 to the first buffer circuit 61, and switches the switches SW3 and SW4 to the side of the first buffer circuit 61. The first buffer circuit 61 outputs the control signals Sn1 and Sp1 to the switches SW3 and SW4 as the control signals Sn61 and Sp61, respectively. Furthermore, the control signals Sn61 and Sp61 are outputted as the control signals Sn and Sp. Then, when the voltage level of the power supply switching signal S20 is switched from the high level to the low level at the timing t1, the control signal generator circuit 51c generates and outputs the control signals Sn2 and Sp2 to the second buffer circuit 62. The second buffer circuit 62 outputs the control signals Sn2 and Sp2 to the switches SW3 and SW4, as the control signals Sn62 and Sp62, respectively. At this time, the output timing of the control signals Sn62 and Sp62 is the timing t2 lagging behind the timing t1 by Δt12, due to the operation delay of the logic circuit in the second buffer circuit 62, and the delay of the parasitic element caused by the layout. Then, the control signal generator circuit 51c stops generating the control signals Sn1 and Sp1 at a timing t3 lagging behind the timing T1 by the delay time Δt51, and switches the switches SW3 and SW4 to the side of the second buffer circuit 62.

Therefore, even when the output timing of the control signals Sn62 and Sp62 is provided at the timing t2 lagging behind the timing t1, the control signal Sn can be smoothly switched from the control signal Sn61 to the control signal Sn62 at the timing t3.

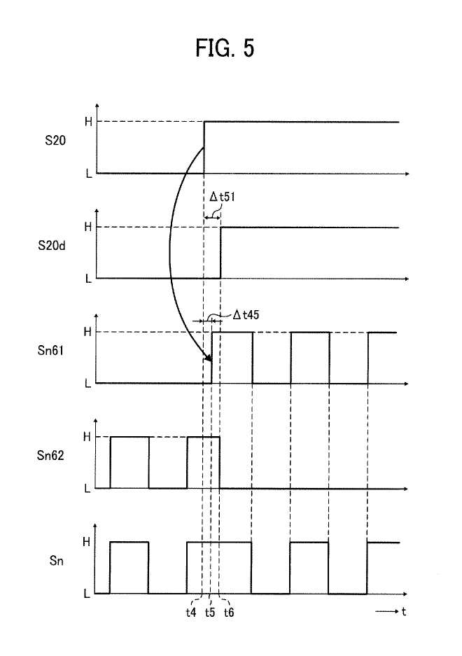

FIG. 5 is a timing chart illustrating an operation of the switching regulator 1A in FIG. 2 when the voltage level of the power supply switching signal S20 is switched from the low level to the high level. When the voltage level of the power supply switching signal S20 is the low level, the control signal generator circuit 51c generates and outputs the control signals Sn2 and Sp2 to the second buffer circuit 62, and switches the switches SW3 and SW4 to the side of the second buffer circuit 62. The second buffer circuit 62 outputs the control signals Sn2 and Sp2 to the switches SW3 and SW4 as the control signals Sn62 and Sp62, respectively. Furthermore, the control signals Sn62 and Sp62 are outputted as the control signals Sn and Sp. Then, when the voltage level of the power supply switching signal S20 is switched from the low level to the high level at the timing t4, the control signal generator circuit 51c generates and outputs the control signals Sn1 and Sp1 to the first buffer circuit 61.

The first buffer circuit 61 outputs the control signals Sn1 and Sp1 to the switches SW3 and SW4 as the control signals Sn61 and Sp61, respectively. At this time, the output timing of the control signals Sn61 and Sp61 is a timing t5 lagging behind the timing t4 by Δt45, due to the operation delay of the logic circuit in the first buffer circuit 61, and the delay of the parasitic element caused by the layout. Then, the control signal generator circuit 51c stops generating the control signals Sn2 and Sp2 at a timing t6 lagging behind the timing t4 by a delay time Δt51, and switches the switches SW3 and SW4 to the side of the first buffer circuit 61.

Therefore, even when the output timing of the control signals Sn61 and Sp61 is provided at the timing t5 lagging behind the timing t4, the control signal Sn can be smoothly switched from the control signal Sn62 to the control signal Sn61 at the timing t6.

As described above, according to the present embodiment, the control signal generator circuit 51c controls the second buffer circuit 62 so that the control signals Sn62 and Sp62 are generated at the first timing when the output voltage Vout becomes equal to or higher than the input Vin, and switches the control signals from the control signals Sn61 and Sp61 from the first buffer circuit 61 to the control signals Sn62 and Sp62 from the second buffer circuit 62, at the timing lagging behind the first timing by the predetermined delay time Δt51. Furthermore, the control signal generator circuit 51c controls the first buffer circuit 61 so that the control signals Sn61 and Sp61 are generated at the second timing when the output voltage Vout becomes lower than the input Vin, and switches the control signals from the control signals Sn62 and Sp62 from the second buffer circuit 62 to the control signals Sn61 and Sp61 from the first buffer circuit 61, at the timing lagging behind the second timing by the predetermined delay time Δt51. Therefore, compared with the first embodiment, the control signal Sn can be smoothly switched between the control signal Sn61 and Sn62, so that the switching regulator 1A can be stably operated.

In addition, the voltage level of the high-level control signals Sn61 and Sp61 from the first buffer circuit 61 corresponds to the input voltage Vin, and the voltage level of the high-level control signals Sn62 and Sp62 from the second buffer circuit 62 corresponds to the output voltage Vout, which are different from each other. However, the output voltage Vout and the input voltage Vin are substantially equal to each other at the timing when the voltage level of the power supply switching signal S20 is switched, so that no problem arises in the operation of the switching regulator 1A.

(Variation of First and Second Embodiments)

In the first and second embodiments, each of the PWM logic circuits 51A and 51B controls the switches SW3 and SW4 without regard to the on timing of the switching transistor 24, but the present disclosure is not limited to this. Each of the PWM logic circuits 51A and 51B may switch the control signals from the control signals Sn61 and Sp61 from the first buffer circuit 61 to the control signals Sn62 and Sp62 from the second buffer circuit 62, or switch the control signals from the control signals Sn62 and Sp62 from the second buffer circuit 62 to the control signals Sn61 and Sp61 from the first buffer circuit 61, in synchronization with a predetermined setting signal indicating the timing when the switching transistor 24 is turned on. In this case, more specifically, an oscillation circuit which generates the above setting signal is provided in each of the buffer circuits 61 and 62, and the buffer circuits 61 and 62 generate the control signals Sn61 and Sp61, and Sn62 and Sp62, respectively, in synchronization with the setting signal. Furthermore, each of the PWM logic circuits 51A and 51B switches the switches SW3 and SW4 in synchronization with the setting signal from the buffer circuit 61 or 62. Thus, compared with the first and second embodiments, the output voltage Vout can be further stabilized.

(Third Embodiment)

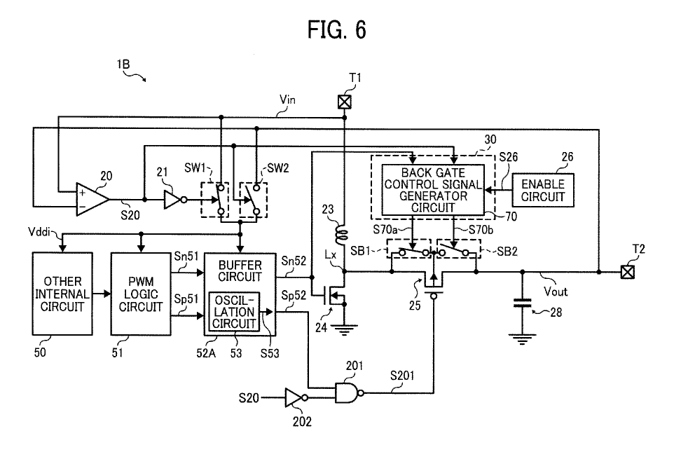

FIG. 6 is a block diagram illustrating a switching regulator 1B according to a third embodiment of the present disclosure. The switching regulator according to the present embodiment is different from the switching regulator 1x in FIG. 14 in that the switching regulator according to the present embodiment includes a buffer circuit 52A instead of the buffer circuit 52, and further includes a back gate control circuit 30, a NAND gate 201, and an inverter 202. Here, the back gate control circuit 30 includes a back gate control signal generator circuit 70. Hereinafter, points different from the switching regulator 1X in FIG. 14 will be described.

Referring to FIG. 6, the buffer circuit 52A includes an oscillation circuit 53 which generates a setting signal S53 serving as a pulse signal having a predetermined frequency. The buffer circuit 52A outputs the control signals Sn51 and Sp51 from the PWM logic circuit 51, to the gate of the switching transistor 24 and a first input terminal of the NAND gate 201, respectively, as the control signals Sn52 and Sp52, in synchronization with the setting signal S53. More specifically, the buffer circuit 52A generates the control signal Sn52 so that it rises at the rising timing of the setting signal S53. In addition, the control signal Sn52 is outputted to the gate of the switching transistor 24, and the back gate control signal generator circuit 70. The back gate control signal generator circuit 70 generates back gate control signals S70a and S70b as will be described in detail below, based on the power supply switching signal S20, the control signal Sn52, and the enable signal S26, and outputs the back gate control signals S70a and S70b to the back gate switches SB1 and SB2, respectively. In addition, the power supply switching signal S20 is outputted to a second input terminal of the NAND gate 201 through the inverter 202, and an output signal from the NAND gate 201 is outputted to the gate of the synchronous rectifying transistor 25 as a control signal S201.

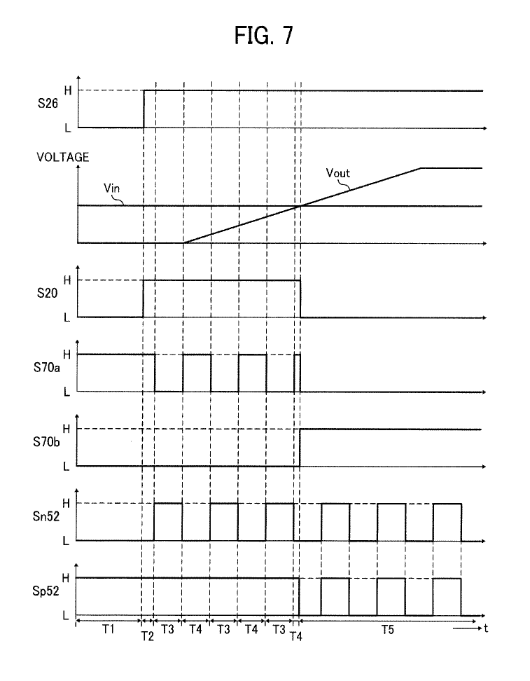

FIG. 7 is a timing chart illustrating an operation of the switching regulator 1B in FIG. 6. A description will be given of the operation of the switching regulator 1B in FIG. 6 in periods T1 to T5 in FIG. 7.

(1) Period T1

In the period T1, the switching regulator 1B in FIG. 6 is in a standby state, and the low-level enable signal S26 is generated. The back gate control signal generator circuit 70 generates the high-level back gate control signal S70a and the low-level back gate control signal S70b, in response to the low-level enable signal S26. In response to this, the back gate switch SB1 is turned on, while the back gate switch SB2 is turned off. Therefore, a current path is cut from the input terminal T1 to the output terminal T2. In addition, the level of the output voltage Vout is a ground level. Furthermore, since the comparator 20 is not operated, the voltage level of the power supply switching signal S20 is the low level.

(2) Period T2

In the period T2, when the switching regulator 1B is activated and starts its operation, the high-level enable signal S26 is outputted. In addition, since the output voltage Vout is lower than the input voltage Vin, the comparator 20 generates the high-level power supply switching signal S20, and the internal power supply voltage Vddi becomes equal to the input voltage Vin substantially. Furthermore, the voltage level of the control signal Sn52 is the low level. In addition, since the output voltage Vout is lower than the input voltage Vin, the hi_{g}h-level control signal S201 is generated in response to the high-level power supply switching signal S20, and in response to this, the synchronous rectifying transistor 25 is turned off. The back gate control signal generator circuit 70 generates the high-level back gate control signal S70a and the low-level back gate control signal S70b, in response to the high-level enable signal S26, the high-level power supply switching signal S20, and the low-level control signal Sn52. In response to this, the back gate switch SB1 is turned on, while the back gate switch SB2 is turned off. Therefore, similar to the period T1, the current path is cut from the input terminal T1 to the output terminal T2.

(3) Period T3

Then, in the period T3, the switching transistor 24 is turned on in response to the high voltage level of the control signal Sn52 which synchronizes with the setting signal S53. Therefore, a voltage level of a junction node Lx substantially reaches the ground level. In addition, the back gate control signal generator circuit 70 generates the low-level back gate control signals S70a and S70b, in response to the high-level enable signal S26, the high-level power supply switching signal S20, and the high-level control signal Sn52. In response to this, the back gate switches SB1 and SB2 are turned off. When the back gate switch SB1 is turned on and the back gate switch SB2 is turned off in the period T3 similar to the period T1, a current flows from the output terminal T2 to the ground through a parasitic diode of the synchronous rectifying transistor 25, the junction node Lx, and the switching transistor 24, but according to the present embodiment, the back gate switches SB1 and SB2 are turned off in the period T3, so that the current can be prevented from reversely flowing from the output terminal T2 to the ground.

(4) Period T4

Then, in the period T4, the switching transistor 24 is turned off, in response to the low-level control signal Sn52. In addition, since the output voltage Vout is lower than the input voltage Vin, the high-level control signal S201 is generated, and similar to the period T3, the synchronous rectifying transistor 25 is in the off state. Similar to the period T2, the back gate control signal generator circuit 70 generates the high-level back gate control signal S70a and the low-level back gate control signal S70b, in response to the high-level enable signal S26, the high-level power supply switching signal S20, and the low-level control signal Sn52. In response to this, the back gate switch SB1 is turned on, while the back gate switch SB2 is turned off. At this time, since energy is left in the coil 23, the coil 23 tries to apply a current. However, the voltage level of the control signal S201 to the synchronous rectifying transistor 25 is the high level (level of the input voltage Vin), and in response to this, the synchronous rectifying transistor 25 is in the off state. As a result, the voltage level of the junction node Lx is eased. Since the junction node Lx is connected to the source of the synchronous rectifying transistor 25, the voltage of the junction node Lx is increased, and when a voltage between the gate and the source of the synchronous rectifying transistor 25 (voltage of the junction node Lx—input voltage Vin) exceeds a threshold voltage Vth of the synchronous rectifying transistor 25. the synchronous rectifying transistor 25 is turned on, and the current flows from the junction node Lx to the output terminal T2, so that the output voltage Vout is increased.

(5) Period T5

When the output voltage Vout is increased and becomes equal to or higher than the input voltage Vin, the comparator 20 generates the low-level power supply switching signal S20, and the internal power supply voltage Vddi substantially reaches the output voltage Vout. In addition, the back gate control signal generator circuit 70 generates the low-level back gate control signal S70a and the high-level back gate control signal S70b, in response to the hi_{g}h-level enable signal S26, and the low-level power supply switching signal S20. In response to this, the back gate switch SB1 is turned off, while the back gate switch SB2 is turned on. Therefore, the current is prevented from reversely flowing from the output terminal T2 to the input terminal T1. In addition, the switching transistor 24 and the synchronous rectifying transistor 25 are turned on in the complementary way.

As described above, when the output voltage Vout is lower than the input voltage Vin, the synchronous rectifying transistor 25 is controlled so as to be always turned off, while when the output voltage Vout is equal to or higher than the input voltage Vin, the synchronous rectifying transistor is controlled so as to be turned on in the complementary way with the switching transistor 24.

As described above, according to the switching regulator in the conventional technology, the switching transistor is in the off state at the time of startup, so that in order to prevent the inrush current, it is necessary to provide the overcurrent protecting circuit on the side of the synchronous rectifying transistor. Meanwhile, according to the switching regulator 1B in the present embodiment, the switching transistor 24 performs the switching operation from the startup of the switching regulator 1B until after the output voltage Vout becomes equal to or higher than the input voltage Vin. Therefore, only by providing the overcurrent protection circuit which monitors a current flowing in the switching transistor 24, the overcurrent of the switching regulator 1B in the all states can be monitored to prevent the inrush current. In addition, the soft start circuit may control the switching transistor 24 only, and not has to control the synchronous rectifying transistor 25, so that the configuration can become considerably simple, compared with the switching regulator in the conventional technology. Therefore, according to the present embodiment, the switching regulator can be superior in efficiency and stability with the simple circuit configuration, compared with the conventional technology.

In addition, according to the present embodiment, the description has been given of the switching regulator 1B which performs the step-up operation in which the output voltage Vout becomes equal to or higher than the input voltage Vin, but the present disclosure is not limited to this, and the switching regulator may perform a step-down operation so that the output voltage Vout reaches a predetermined voltage lower than the input voltage Vin. In this case, the period T5 is eliminated in the timing chart in FIG. 7, but the output voltage Vout is maintained at the predetermined voltage without being increased to the input voltage Vin.

In addition, according to the present embodiment, the comparator 20 operates while the switching regulator 1B is activated, and the enable signal S26 which shows whether the switching regulator 1B is in the standby state or active state is outputted to the back gate control signal generator circuit 70, but the present disclosure is not limited to this. In the case where the comparator 20 operates without regard to whether the switching regulator 1B is in the standby state or the active state, it is not necessary to output the enable signal S26 to the back gate control signal generator circuit 70. In this case, the back gate control signal generator circuit 70 can control the back gate switches SB1 and SB2 based on the power supply switching signal S20 from the comparator 20 even when the switching regulator 1B is in the standby state. Therefore, for example, even when the voltage is applied to the output terminal T2 in the standby state, the current does not flow reversely from the output terminal T2 to the input terminal T1.

In addition, according to the present embodiment, the control signal Sn52 is outputted to the back gate control signal generator circuit 70, but the present disclosure is not limited to this, and for example, a predetermined signal such as the control signal Sn51 to drive the switching transistor 24 may be outputted to the back gate control signal generator circuit 70.

As for the switching regulator 1B according to the third embodiment, the back gate switch SB2 is switched independently of the switching of the switching transistor 24 and the synchronous rectifying transistor 25. When the back gate switch SB2 is switched while the switching transistor 24 is in the on state, and the synchronous rectifying transistor 25 is in the off state, distortion is not generated in the output voltage Vout. However, the distortion could be generated in the output voltage Vout, depending on the switching timing of the back gate switch SB2 or a load condition.

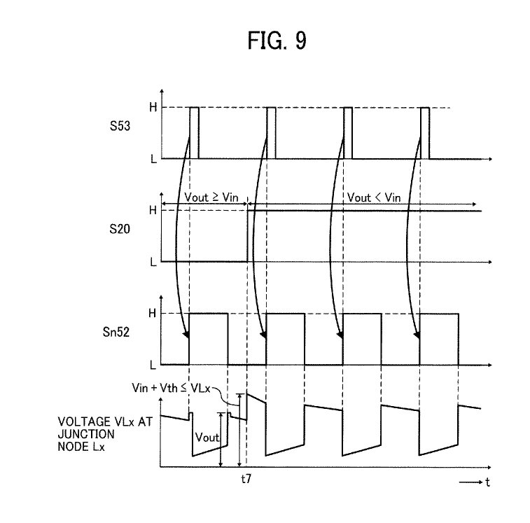

FIG. 9 is a timing chart illustrating an operation of the switching regulator 1B in FIG. 6. Referring to FIG. 9, the voltage level of the power supply switching signal S20 is changed from the low level to the high level at a timing t7 in FIG. 9. Meanwhile, at the timing 7, the voltage level of the control signal Sn52 is the low level, and in response to this, the switching transistor 24 is in the off state. In addition, the synchronous rectifying transistor 25 is in the on state when the voltage level of the power supply switching signal S20 is the low level, and the switching transistor 24 is in the off state. That is, referring to FIG. 9, the back gate switch SB2 is switched at the timing t7 in which the synchronous rectifying transistor 25 is in the on state. In addition, when the voltage level of the power supply switching signal S20 is changed from the low level to the high level at the timing t7, the synchronous rectifying transistor 25 is turned off irrespectively of the on/off of the switching transistor 24. As described above about the period T4 in FIG. 7, a voltage Vlx at the junction node Lx is increased from the input voltage Vin to the voltage equal to or higher than the threshold voltage Vth of the synchronous rectifying transistor 25. Therefore, at the timing t7, an overshoot is generated in a voltage waveform of the junction node Lx, and as a result, the operation of the synchronous rectifying transistor 25 becomes considerably unstable, and the distortion is generated in the output voltage Vout.

Especially, in the case where a relatively large current flows in the synchronous rectifying transistor 25 such as a case where the switching regulator 1B is operated in a current continuity mode, the distortion of the output voltage Vout becomes conspicuous. Furthermore, in the case where a period in which the back gate switches SB1 and SB2 are both in the off state is provided to prevent a flow-through current, at the switching timing of the back gate switch SB2, the back gate of the synchronous rectifying transistor 25 shows high impedance in this period, so that the distortion of the output voltage Vout becomes further conspicuous. As for the switching regulator 1B in which a current as large as several amperes can flow, the synchronous rectifying transistor 25 is destroyed due to the distortion of the output voltage Vout in the worst case.

(Fourth Embodiment)

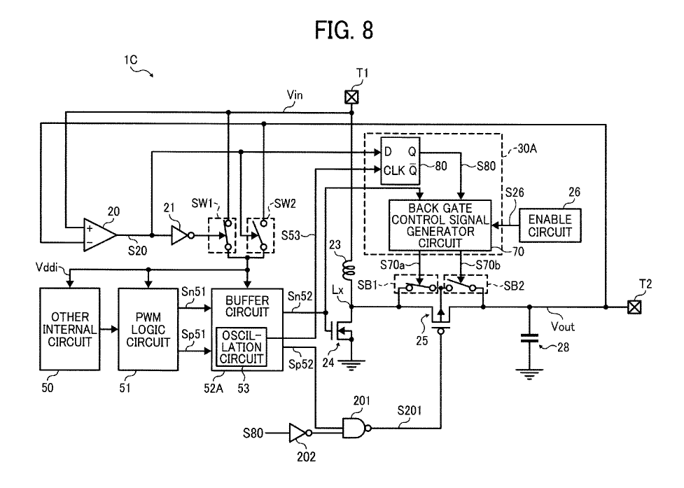

FIG. 8 is a block diagram illustrating a configuration of a switching regulator 1C according to a fourth embodiment of the present disclosure. In order to solve the above problems shown in FIG. 9, the switching regulator 1C according to the present embodiment is different from the switching regulator 1B according to the third embodiment in that a back gate control circuit 30A is provided instead of the back gate control circuit 30. Here, the back gate control circuit 30A includes the back gate control signal generator circuit 70, and a D flip-flop 80. Hereinafter, points different from the third embodiment will be described. Similar to the third embodiment, the buffer circuit 52A outputs the control signals Sn51 and Sp51 from the PWM logic circuit 51 to the gates of the switching transistor 24 and the synchronous rectifying transistor 25, as the control signals Sn52 and Sp52, respectively, in synchronization with the setting signal S53. More specifically, the buffer circuit 52A generates the control signal Sn52 so that the buffer circuit 52A rises at the rising timing of the setting signal S53. That is, the rising timing of the setting signal S53 shows the timing when the switching transistor 24 is turned on and the synchronous rectifying transistor 25 is turned off.

The setting signal S53 is outputted to a clock input terminal CLK of the D flip-flop 80. In addition, the power supply switching signal S20 is outputted to a data input terminal D of the D flip-flop 80. The D flip-flop 80 synchronizes the rising timing and falling timing of the power supply switching signal S20 with the rising timing of the setting signal S53, and outputs a power supply switching signal S80 to the back gate control signal generator circuit 70 and the inverter 202. The back gate control signal generator circuit 70 uses the power supply switching signal S80, instead of the power supply switching signal S20, generates and outputs the back gate control signals S70a and S70b to the back gate switches SB1 and SB2, respectively, similar to the third embodiment. In addition, the NAND gate 201 generates the control signal S201 based on the power supply switching signal S80, instead of the power supply switching signal S20. In general, as for the switching regulator including the synchronous rectifying transistor 25, when the switching transistor 24 is in the on state, the synchronous rectifying transistor 25 is controlled so as to be turned off, so that according to the present embodiment, the back gate control circuit 30A switches the back gate switch SB2 from off to on, or from on to off while the synchronous rectifying transistor 25 is in the off state.

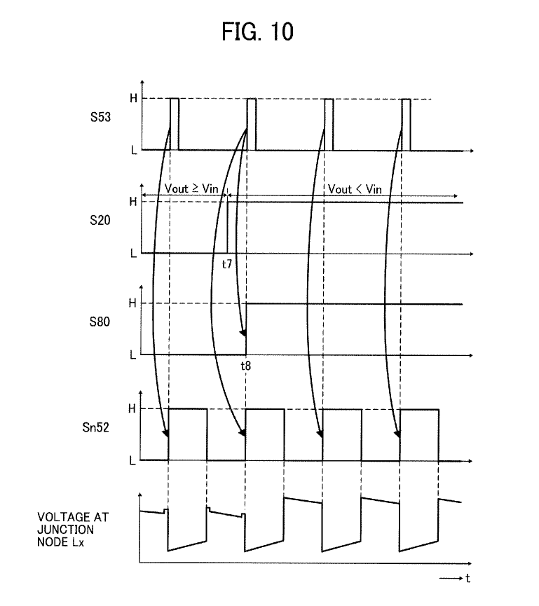

FIG. 10 is a timing chart illustrating an operation of the switching regulator 1C in FIG. 8. Referring to FIG. 10, the voltage level of the power supply switching signal S20 is switched from the low level to high level at the timing t7. Thus, at a next rising timing t8 of the setting signal S53 after the timing t7, the voltage level of the power supply switching signal S80 is switched from the low level to the high level. In addition, at the timing t8, the switching transistor 24 is turned on in response to the high-level control signal Sn52, and the synchronous rectifying transistor 25 is turned off in response to the low-level control signal Sp52. In addition, the back gate control signal generator circuit 70 generates the low-level back gate control signals S70a and S70b, in response to the high-level control signal Sn52, and the high-level power supply switching signal S80. Therefore, the back gate switch SB2 is switched from off to on or from on to off, in synchronization with the setting signal S53 while the synchronous rectifying transistor 25 is in the off state, so that an overshoot does not occur in the voltage waveform of the junction node Lx. Therefore, compared with the third embodiment, the back gate switch SB2 can be smoothly switched, and the switching regulator 1C can be stably operated, so that the synchronous rectifying transistor 25 can be prevented from being destroyed.

In addition, according to the present embodiment, the synchronous rectifying transistor 25 shifts from a first state in which it is controlled so as to be always turned off, to a second state in which it is controlled so as to be turned on in a complementary way with the switching transistor, or shift from the second state to the first state, in synchronization with the setting signal S53 showing the timing when the switching transistor 24 is turned on. Therefore, while the synchronous rectifying transistor 25 is in the off state, the synchronous rectifying transistor 25 shifts from the first state to the second state, or shifts from the second state to the first state. Therefore, compared with the third embodiment, the output voltage Vout can be stabilized.

In addition, according to the present embodiment, the power supply switching signal S80 is generated in synchronization with the setting signal S53, based on the power supply switching signal S20, but the power supply switching signal S20 itself may be outputted to the inverter 21 and the switch SW2 in synchronization with the setting signal S53.

The switching regulator is sometimes operated in a low power consumption mode in which an operation of an unnecessary circuit which is not needed for the operation of the switching regulator is stopped when a load is low, that is, when the load current is smaller than the threshold current, in order to reduce the power consumption and improve the efficiency. Here, the low power consumption mode includes a pulse frequency modulation mode in which pulse frequency modulation control is performed. As for the above switching regulator, when the oscillation circuit 53 is stopped and controlled so as not to generate the setting signal S53 during the operation in the low power consumption mode, the voltage level of the power supply switching signal S80 cannot be changed in the fourth embodiment, and cannot switch the back gate switches SB1 and SB2.

(Fifth Embodiment)

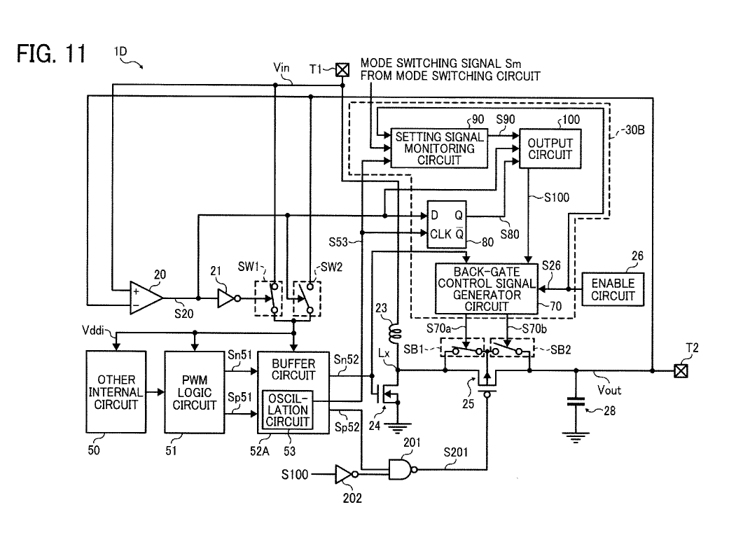

FIG. 11 is a block diagram illustrating a configuration of a switching regulator 1D according to a fifth embodiment of the present disclosure. Referring to FIG. 11, in order to solve the above problems, the switching regulator 1D according to the present embodiment is different from the switching regulator 1C according to the fourth embodiment in that a back gate control circuit 30B is provided instead of the back gate control circuit 30A. Here, the back gate control circuit 30B includes the back gate control signal generator circuit 70, the D flip-flop 80, a setting signal monitoring circuit 90, and an output circuit 100. Hereinafter, points different from the fourth embodiment will be described.

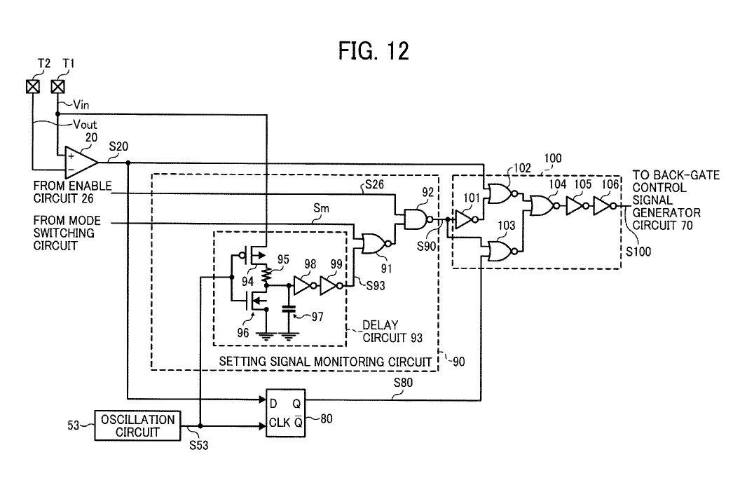

FIG. 12 is a circuit diagram illustrating a configuration of the setting signal monitoring circuit 90 and the output circuit 100 in FIG. 11. Referring to Fig, 12, the setting signal monitoring circuit 90 includes a delay circuit 93, a NOR gate 91, and a NAND gate 92, and the delay circuit 93 includes a PMOS field effect transistor (hereinafter, referred to as the pMOS transistor) 94, an NMOS field effect transistor (hereinafter, referred to as the nMOS transistor) 96, a resistor 95, a capacitor 97, and inverters 98 and 99. In addition, the output circuit 100 includes inverters 101, 105, and 106, and NOR gates 102, 103, and 104.

The pMOS transistor 94 and the nMOS transistor 96 are connected in series between the input terminal Vin and the ground, and constitute an inverter circuit. In addition, the resistor 95 is connected between a source of the pMOS transistor 94 and a drain of the nMOS transistor 96. The drain of the nMOS transistor 96 is grounded through the capacitor 97, and connected to a first input terminal of the NOR gate 91 through the inverters 98 and 99. The setting signal S53 from the oscillation circuit 53 is outputted to the inverter circuit including the pMOS transistor 94 and the nMOS transistor 96. When the voltage level of the setting signal S53 is the low level, the pMOS transistor is turned on, the nMOS transistor is turned off, the resistor 95 and capacitor 97 constitute a RC integration circuit, and the capacitor 97 is charged. Meanwhile, when the voltage level of the setting signal S53 is the high level, the pMOS transistor is turned off, the nMOS transistor is turned on, and the capacitor is discharged through the nMOS transistor 96. Thus, a voltage at both ends of the capacitor 97 is outputted to the first input terminal of the NOA gate 91 through the inverters 98 and 99, as a delay setting signal S93.

Here, a time constant of the RC integration circuit including the resistor 95 and the capacitor 97 is set so as to be greater than a predetermined generation interval threshold value when the setting signal S53 is periodically generated. Therefore, when a generation interval of the setting signal S53 is equal to or less than the predetermined generation interval threshold value, the low-level delay setting signal S93 is generated, but when the generation interval of the setting signal S53 is greater than the predetermined generation interval threshold value, the high-level delay setting signal S93 is generated.

Referring to FIG. 12, a mode switching signal Sm is generated by a mode switching circuit in the switching regulator 1D, and outputted to a second input terminal of the NOR gate 91. Here, the mode switching circuit determines whether or not the load current is in a low load state in which a load current is smaller than the predetermined threshold current, based on an output level of an error amplifier which compares the output voltage Vout flowing in the switching transistor 24 with a predetermined reference voltage, and it generates the high-level mode switching signal Sm in the case of the low load state, while it generates the low-level mode switching signal Sm in the case of the high load state in which the load current is equal to or larger than the threshold current. In addition, a PFM (Pulse Frequency Modulation) control is performed in response to the high-level mode switching signal Sm, and PWM control is performed in response to the low-level mode switching signal Sm.

Furthermore, an output signal from the NOR gate 91 is outputted to a first input terminal of the NAND gate 92, and the enable signal S26 from the enable circuit 26 is outputted to a second input terminal of the NAND gate 92. Thus, an output signal from the NAND gate 92 is outputted as a setting signal monitoring signal S90 to a first input terminal of the NOA gate 103, and outputted to a first input terminal of the NOA gate 102 through the inverter 101. In addition, the power supply switching signal S80 from the D flip-flop 80 is outputted to a second input terminal of the NOA gate 103, and the power supply switching signal S20 is outputted to a second input terminal of the NOA gate 102. In addition, output signals from the NOA gates 102 and 103 are outputted to the NOA gate 104, and an output signal from the NOA gate 104 is outputted to the back gate control signal generator circuit 70 and the inverter 202 through the inverters 105 and 106, as a power supply switching signal S100.

As for the setting signal monitoring circuit 90 in FIG. 12, when the generation interval of the setting signal S53 is equal to or smaller than the predetermined generation interval threshold value, the voltage level of the delay setting signal S93 is the low level. In addition, when the generation interval of the setting signal S53 is equal to or smaller than the predetermined generation interval threshold value, the PWM control is performed, so that the voltage level of the mode switching signal Sm is the low level, and the voltage level of the enable signal S26 is the high level. Therefore, the voltage level of the setting signal monitoring signal S90 becomes the low level, and the output circuit 100 outputs the power supply switching signal S80 from the D flip-flop 80 to the back gate control signal generator circuit 70 as the power supply switching signal S100.

In addition, the setting signal monitoring circuit 90 generates the high-level setting signal monitoring signal S90 in response to at least one of the high-level delay setting signal S93 showing that the generation interval of the setting signal S53 is greater than the predetermined generation interval threshold value, the low-level enable signal S26 showing the standby state, and the high-level mode switching signal Sm showing the low load state. In response to this, the output circuit 100 outputs the power supply switching signal S20 from the comparator 20 to the back gate control signal generator circuit 70 as the power supply switching signal S100.

The back gate control signal generator circuit 70 uses the power supply switching signal S100 instead of the power supply switching signal S80, generates and outputs the back gate control signals S70a and S70b to the back gate switches SB1 and SB2, respectively, similar to the third embodiment.

According to the present embodiment, when the generation interval of the setting signal S53 is greater than the predetermined generation interval threshold value, the back gate control circuit 30B switches the back gate switch SB2 from off to on, or from on to off, based on the power supply switching signal S20, without using the setting signal S53. In addition, in this case, because of the low load state, the current flowing in the synchronous rectifying transistor 25 is relatively small, and the distortion of the output voltage Vout described with reference to FIG. 9 is not substantially generated. Therefore, even when the back gate switch SB2 is switched, the synchronous rectifying transistor 25 is not destroyed. In addition, at the time of the operation in the low power consumption mode, a ripple of the output voltage Vout is relatively large, so that the distortion of the output voltage Vout due to the switching of the back gate switch SB2 does not cause a serious problem.

In addition, according to the present embodiment, the NAND gate 201 generates the control signal S201 based on the power supply switching signal S100, instead of the power supply switching signal S80. Therefore, when the generation interval of the setting signal S53 is greater than the predetermined generation interval threshold value, the synchronous rectifying transistor 25 shifts from the above-described first state to the above-described second state or shifts from the second state to the first state, based on the power supply switching signal S20, without regard to the setting signal S53. Thus, compared with the fourth embodiment, the output voltage Vout can be stabilized.

(Sixth Embodiment)

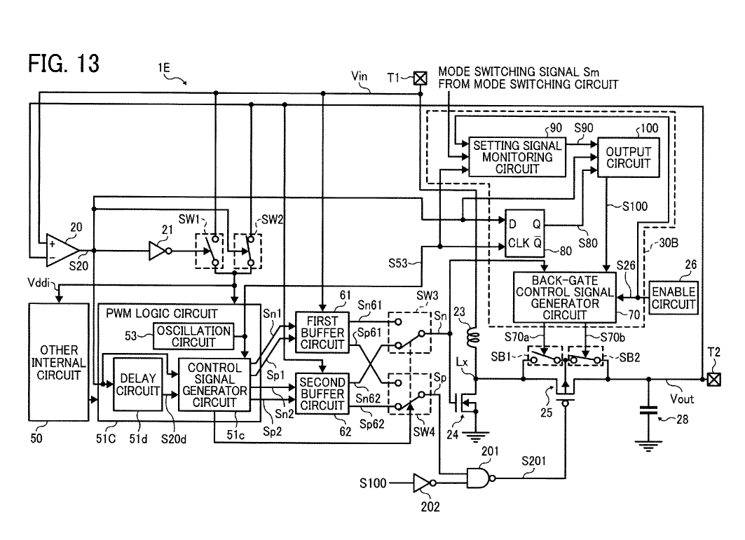

FIG. 13 is a block diagram illustrating a configuration of a switching regulator 1E according to a sixth embodiment of the present disclosure. The switching regulator 1E according to the present embodiment is different from the switching regulator 1A according to the second embodiment in that instead of the PWM logic circuit 51B, a PWM logic circuit 51C serving as the switching control circuit is provided, and the back gate control signal generator circuit 30B is further provided. In addition, the back gate control signal generator circuit 30B operates similar to the back gate control signal generator circuit 30B according to the fifth embodiment. Hereinafter, points different from the second and fifth embodiments will be described.

Referring to FIG. 13, the PWM logic circuit 51C is different from the PWM logic circuit 51B in that the oscillation circuit 53 is further provided. The oscillation circuit 53 generates and outputs the setting signal S53 serving as the pulse signal having the predetermined frequency to the control signal generator circuit 51c, the setting signal monitoring circuit 90, and the D flip-flop 80. The control signal generator circuit 51c generates the control signals Sn1 and Sp1, and the control signals Sn2 and Sp2, in synchronization with the setting signal S 53, similar to the second embodiment. In addition, the control signal Sn from the switch SW3 is outputted to the gate of the switching transistor 24, and the back gate control signal generator circuit 70. The back gate control signal generator circuit 70 generates the back gate control signals S70a and S70b, based on the control signal Sn, the enable signal S26, and power supply switching signal S100, similar to the fifth embodiment.

Therefore, according to the present embodiment, similar to the second embodiment, since the synchronous rectifying transistor 25 is not turned on at the timing to turn off the synchronous rectifying transistor 25, the control signal Sn can be smoothly switched between the control signals Sn61 and Sn62, so that the switching regulator 1E superior in efficiency and stability can be provided, compared with the conventional technology. In addition, similar to the fifth embodiment, the switching regulator can be superior in efficiency and stability with a simple circuit configuration, compared with the conventional technology.

In addition, the back gate control circuit 30 or 30A may be provided in the switching regulator 1A according to the second embodiment. Furthermore, the back gate control circuit 30, 30A, or 30B may be provided in the switching regulator 1 according to the first embodiment.

In addition, the back gate switch SB2 is switched in synchronization with the setting signal S53 in the fourth to sixth embodiments, but the present disclosure is not limited to this, and the switches SW1 and SW2 may be switched also in synchronization with the setting signal S53.

Additional modifications and variations of the present disclosure are possible in light of the above teachings. It is therefore to be understood that within the scope of the appended claims the disclosure may be practiced other than as specifically described herein.

According to the switching regulator in the first disclosure, the switching control circuit assumes control such that the first and second signals are outputted from the first buffer circuit to the switching transistor and the synchronous rectifying transistor, respectively, in response to a power supply switching signal indicating that the output voltage is lower than the input voltage, while it assumes control such that the first and second control signals are outputted from the second buffer circuit to the switching transistor and the synchronous rectifying transistor, respectively, in response to a power supply switching signal indicating that the output voltage is equal to or higher than the input voltage, so that it is possible to provide the switching regulator superior in efficiency and stability with the simple circuit configuration, compared with the conventional technology.

According to the switching regulator in the second disclosure, the back gate control circuit assumes control such that when the output voltage is lower than the input voltage, and the itching transistor is in an on state, the first back gate switch is turned off and the second back gate switch is turned off, when the output voltage is lower than the input voltage, and the switching transistor is in an off state, the first back gate switch is turned on and the second back gate switch is turned off, and when the output voltage is equal to or higher than the input voltage, the first back gate switch is turned off and the second back gate switch is turned on, so that it is possible to provide the switching regulator superior in efficiency and stability with the simple circuit configuration, compared with the conventional technology.

According to the switching regulator in the third disclosure, the second back gate switch is switched from off to on, or from on to off when the synchronous rectifying transistor is in an off state, it is possible to provide the switching regulator superior in efficiency and stability with the simple circuit configuration, compared with the conventional technology.

Numerous additional modifications and variations are possible in light of the above teachings. It is therefore to be understood that, within the scope of the appended claims, the disclosure of this patent specification may be practiced otherwise than as specifically described herein.

What is claimed is:

1. A switching regulator comprising:
an input terminal through which an input voltage is inputted;
an output terminal to output an output voltage;
a coil having one end connected to the input terminal;
a switching transistor connected between the other end of the coil and the ground, and driven by an inputted first control signal;
a synchronous rectifying transistor connected between a junction node between the coil and the switching transistor, and the output terminal, and driven by an inputted second control signal;
a switching control circuit to control the switching transistor and the synchronous rectifying transistor so as to convert the input voltage inputted through the input terminal into the predetermined output voltage for output through the output terminal; and
a comparator to compare the output voltage with the input voltage, and generate a power supply switching signal indicating the compared result;
a first buffer circuit operated by the input voltage; and
a second buffer circuit operated by the output voltage,
wherein the switching control circuit assumes control such that the first and second signals are outputted from the first buffer circuit to the switching transistor and the synchronous rectifying transistor, respectively, in response to a power supply switching signal indicating that the output voltage is lower than the input voltage, while the switching control circuit assumes control such that the first and second control signals are outputted from the second buffer circuit to the switching transistor and the synchronous rectifying transistor, respectively, in response to a power supply switching signal indicating that the output voltage is equal to or higher than the input voltage.

2. The switching regulator according to claim 1, wherein the switching control circuit controls the second buffer circuit such that the first and second control signals are generated, at a first timing when the output voltage becomes equal to or higher than the input voltage, and then the first and second control signals from the first buffer circuit is switched to the first and second control signals from the second buffer circuit, and outputted to the switching transistor and the synchronous rectifying transistor, respectively, at a timing lagging behind the first timing by a predetermined delay time, and
the switching control circuit controls the first buffer circuit such that the first and second control signals are generated, at a second timing when the output voltage becomes lower than the input voltage, and then the first and second control signals from the second buffer circuit is switched to the first and second control signals from the first buffer circuit, and outputted to the switching transistor and the synchronous rectifying transistor, respectively, at a timing lagging behind the second timing by a predetermined delay time.

3. The switching regulator according to claim 1, wherein the switching control circuit assumes control such that the first and second control signals from the first buffer circuit is switched to the first and second control signals from the second buffer circuit, or the first and second control signals from the second buffer circuit is switched to the first and second control signals from the first buffer circuit, in synchronization with a predetermined setting signal indicating a timing when the switching transistor is turned on.

4. A switching regulator comprising:
an input terminal through which an input voltage is inputted;
an output terminal to output an output voltage;
a coil having one end connected to the input terminal;
a switching transistor connected between the other end of the coil and the ground;
a synchronous rectifying transistor connected between a junction node between the coil and the switching transistor, and the output terminal;
a first back gate switch connected between a back gate of the synchronous rectifying transistor and the junction node;
a second back gate switch connected between the back gate of the synchronous rectifying transistor and the output terminal;
a switching control circuit to control the switching transistor and the synchronous rectifying transistor so as to convert the input voltage inputted through the input terminal into the predetermined output voltage for output through the output terminal; and
a back gate control circuit to control the first and second back gate switches,
wherein the back gate control circuit assumes control such that when the output voltage is lower than the input voltage, and the switching transistor is in an on state, the first back gate switch is turned off and the second back gate switch is turned off, when the output voltage is lower than the input voltage, and the switching transistor is in an off state, the first back gate switch is turned on and the second back gate switch is turned off, and when the output voltage is equal to or higher than the input voltage, the first back gate switch is turned off and the second back gate switch is turned on, and the synchronous rectifying transistor is controlled so as to be always turned off when the output voltage is lower than the input voltage, while the synchronous rectifying transistor is controlled so as to be turned on in a complementary way with the switching transistor when the output voltage is equal to or higher than the input voltage.

5. The switching regulator according to claim 4, wherein the back gate control circuit switches the second back gate switch from off to on, or from on to off, in synchronization with a predetermined setting signal indicating a timing when the switching transistor is turned on, so that the second back gate switch is switched from off to on, or from on to off when the synchronous rectifying transistor is in the off state.

6. The switching regulator according to claim 5, further comprising:
a comparator to comparing the output voltage with the input voltage to generate a power supply switching signal indicating the compared result,
wherein the back gate control circuit switches the second back gate switch from off to on, or from on to off, based on the power supply switching signal, without using the setting signal when a generation interval of the setting signal is greater than a predetermined generation interval threshold value.

7. The switching regulator according to claims 4, wherein the synchronous rectifying transistor shifts from a first state controlled to be always turned off, to a second state controlled so as to be turned on in a complementary way with the switching transistor, or shifts from the second state to the first state, in synchronization with the predetermined setting signal indicating the timing when the switching transistor is turned on, so that the first state is shifted to the second state, or the second state is shifted to the first state when the synchronous rectifying transistor is in the off state.

8. The switching regulator according to claim 7, further comprising:
a comparator to compare the output voltage with the input voltage to generate a power supply switching signal indicating the compared result,
wherein the synchronous rectifying transistor shifts from the first state to the second state, or shifts from the second state to the first state, based on the power supply switching signal, without regard to the setting signal when a generation interval of the setting signal is greater than a predetermined generation interval threshold value.

9. A switching regulator comprising:
an input terminal through which an input voltage is inputted;
an output terminal to output an output voltage;
a coil having one end connected to the input terminal;
a switching transistor connected between the other end of the coil and the ground;
a synchronous rectifying transistor connected between a junction node between the coil and the switching transistor, and an output terminal;
a first back gate switch connected between a back gate of the synchronous rectifying transistor and the junction node;
a second back gate switch connected between the back gate of the synchronous rectifying transistor and the output terminal;
a switching control circuit to control the switching transistor and the synchronous rectifying transistor so as to convert the input voltage inputted through the input terminal into the predetermined output voltage and outputted from the output terminal; and
a back gate control circuit to control the first and second back gate switches,
wherein the back gate control circuit switches the second back gate switch from off to on, or from on to off when the synchronous rectifying transistor is in an off state.
